(19) United States
(12) Patent Application Publication
(10) Pub. No.: US 2007/0247046 A1
(43) Pub. Date: Oct. 25, 2007

(54) Method for changing color of light projected outward from a backlight module

(76) Inventors: Che-Lin Wu, Tainan City (TW); Anderson T. Yen, Kaohsiung City (TW); Fu-San Yen, Kaohsiung City (TW); Ming-Chang Liu, Kaohsiung City (TW); Hsietung S. Tsai, Kaohsiung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/407,224

(22) Filed: Apr. 20, 2006

(51) Int. Cl. H01J 61/40; H01J 5/16; H01K 1/26; H01K 1/30

(52) U.S. Cl. 313/112; 313/110

(57) ABSTRACT

A light source is positioned on a lateral side of a light guide of a backlight module, and several optical films are positioned on the light guide for diffusing and enhancing brightness of light projected from the light source; in manufacturing one of the optical films, pigments or dyes are added to and mixed with the coating material of the optical film for modifying color of the optical film; thus, color of the light projected from the light source will be harmonized and mixed with the color of the color modified optical film, and consequently overall color of light projected out of the backlight module is changed.

### BACKGROUND OF THE INVENTION

1. Field of the invention

The present invention relates to a method for changing color of light projected outward from a backlight module, more particularly one, which is to change color of light projected outward from a backlight module by means of changing the color of an optical film so as to make the outward projected light harmonized and mixed with the color of the optical film.

2. Brief Description of the Prior Art

LCD displays are getting more popular because they are thin, light in weight, and easily portable.

Backlight module is one of the major units of an LCD (Liquid Crystal Display). A typical backlight module includes a light source (or light sources), a light guide, top and bottom brightness enhancement films, and top and bottom diffusers; the light guide has scattering dots, and the bottom diffuser, the bottom brightness enhancement film, the top brightness enhancement film, and the top diffuser are positioned on the light guide in sequence, and a light source is usually positioned on a side of the light guide. Light emitted by the light source will travel through the light guide, and will be guided to viewing direction by means of the scattering dots of the light guide, and the bottom diffuser will homogenize the light passing from the light guide, and the top and the bottom brightness enhancement films will enhance the brightness of the light projected outward, and the top diffuser will make the outwards projected light even more homogenized. Consequently, the light projected out of the backlight module has enhanced brightness and uniformity.

Currently, cold cathode Fluorescent Lamp (CCFL) or light emitting diodes are most common light sources being used on backlight module. The color of light from CCFL or LED is fixed once they are produced. Furthermore, some light emitting diodes, e.g. blue ones and white ones, are relatively expensive therefore it will take much cost to change the color of light. In the meantime, backlight module manufacturers have limited color selections on the light sources, so is the color of light projected out of backlight unit confined.

### SUMMARY OF THE INVENTION

It is a main object of the invention to provide a method for changing the color of light projected outwards from a backlight module.

According to the method of the present invention, a light source is positioned on a side of a light guide of a backlight module, and several optical films are positioned on top of the light guide for diffusing and enhancing brightness of the light projected from the projecting light source; in manufacturing one of the optical films, pigments or dyes are added to and mixed with coating material of the optical film for changing color of the optical film. Consequently, color of the light projected from the light source will be harmonized and mixed with the color of the color modified optical film, and consequently overall color of light projected out of the backlight module is changed.

### BRIEF DESCRIPTION OF THE DRAWINGS

The present invention will be better understood by referring to the accompanying drawings, wherein:

FIG. 1 is a view showing the structure of the backlight module in the present invention,

FIG. 2 is a flow chart of the first preferred embodiment of the present invention,

FIG. 3 is a flow chart of the second preferred embodiment of the present invention, and

FIG. 4 is a view showing the CIE 1976 ( L*a*b) color space.

### DETAILED DESCRIPTION OF THE PREFERRED EMBODIMENTS

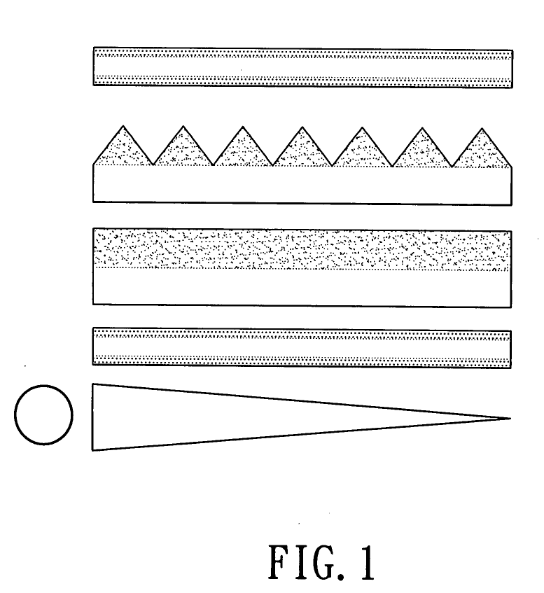

Referring to FIG. 1, a backlight module 1 of the present invention includes a light guide 11, a bottom diffuser 12 on the light guide 11, a bottom brightness enhancement film (BEF) 13 on the bottom diffuser 12, a top brightness enhancement film 14 on the bottom brightness enhancement film 13, a top diffuser 15 on the top brightness enhancement film 14, and a light source 16 positioned on a lateral side of the light guide 11 used for guiding light to cover whole viewing surface of Liquid Crystal Display via the light guide 11, the bottom diffuser 12, the bottom brightness enhancement film 13, the top brightness enhancement film 14, and the top diffuser 15; thus, the light is guided, diffused, and enhanced in brightness.

The method of changing the color of light from the backlight module 1 is to change the color of one of the optical films, i.e. the top diffuser 15, the bottom diffuser 12, the top brightness enhancement film 14 and bottom brightness enhancement film 13, such that color of light projected from the light source 16 will be mixed with the color of any of these color modified optical films and the color of the light projected out of backlight module 1 is changed.

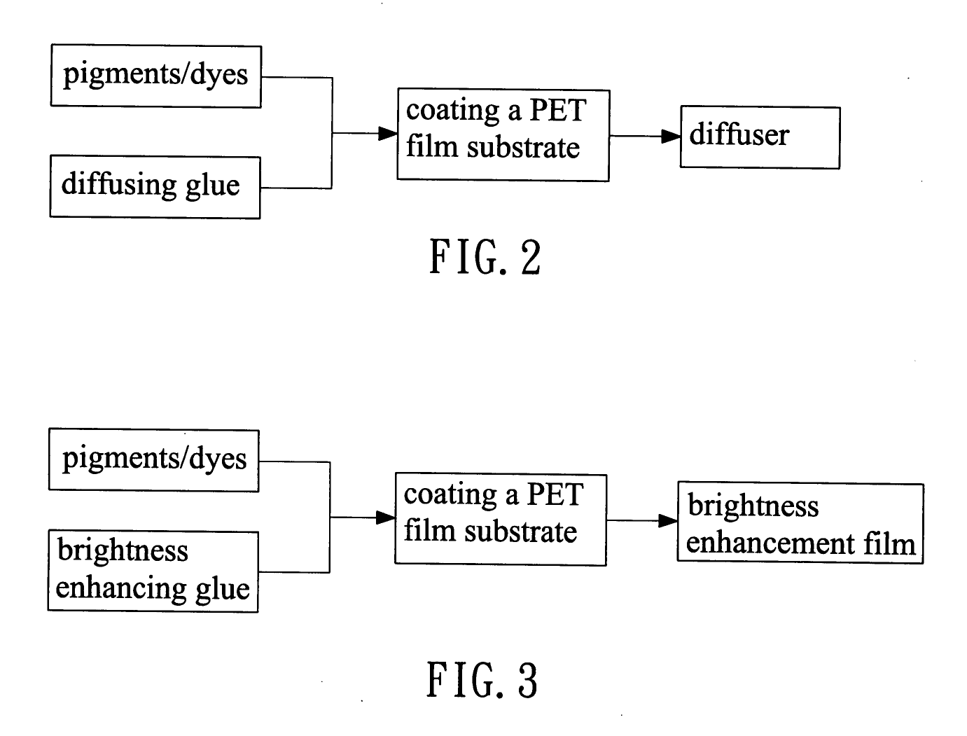

FIGS. 1 and 2 show a first preferred embodiment of the present invention. The top diffuser 15 is made by means of forming a diffusive coating 152 on a PET film substrate 151, which diffusive coating 152 can diffuse light. And, the bottom diffuser 12 is made by means of forming a diffusive coating 122 on a PET film substrate 121 which can diffuse light. The forming materials of the diffusing coatings 152 or 122 have selected pigments or dyes added thereto and mixed therewith such that color of the top and the bottom diffusers 15 and 12 is established according to the color of the pigments or dyes after the PET film substrate 121 and 151 are coated with the color modified coating materials. Color of the light projected from the light source 16 will be harmonized and mixed with the color of the top diffuser 15 or the bottom diffuser 12 after the top and the bottom diffusers 15 and 12 are assembled onto the light guide 11; thus, the output color of the backlight unit (not shown) will be changed.

FIGS. 1 and 3 show a second preferred embodiment of the present invention. The top brightness enhancement film 14 is made by means of forming a coating layer 142 with required refractive index on a PET film substrate 141 as well as shaping the coating layer 142 into a three dimensional light gathering shape (prism) with a mold. And, the bottom brightness enhancement film 13 is made by means of forming a coating layer 132 with required refractive index on a PET film substrate 131 as well as shaping the coating layer 132 into a three dimensional light gathering shape (prism) with a mold. The coating materials of the coating layers 132 and 142 have selected pigments or dyes added thereto and mixed therewith such that color of the top and the bottom brightness enhancement films 14 or 13 is established according to the color of the selected pigments or dyes after the PET film substrates 141 and 131 are coated with the color modified coating materials. Color of the light projected from the light source 16 will be harmonized and mixed with the color of the top and the bottom brightness enhancement films 14 and 13 after the top and the bottom brightness enhancement films 14 and 13 are assembled onto the light guide 11; thus, the output color of the backlight unit will be changed.

Followings are data obtained through experiments, which are carried out to find out the relations between the color of the top brightness enhancement film 14 (or the bottom brightness enhancement film 13) and the color of light projected outward from the backlight module 1:

| | Color of dyes | | | |
|---|---|---|---|---|
| | No dye added | | | |
| | (original color) | red | blue | Green |
| Film thickness (μm) | 30 | 30 | 30 | 30 |
| L | 92.52 | 92.0 | 88.65 | 89.56 |
| a | −0.3 | 0.44 | −3.58 | −3.69 |
| b | 2.7 | 6.47 | −3.22 | 2.42 |

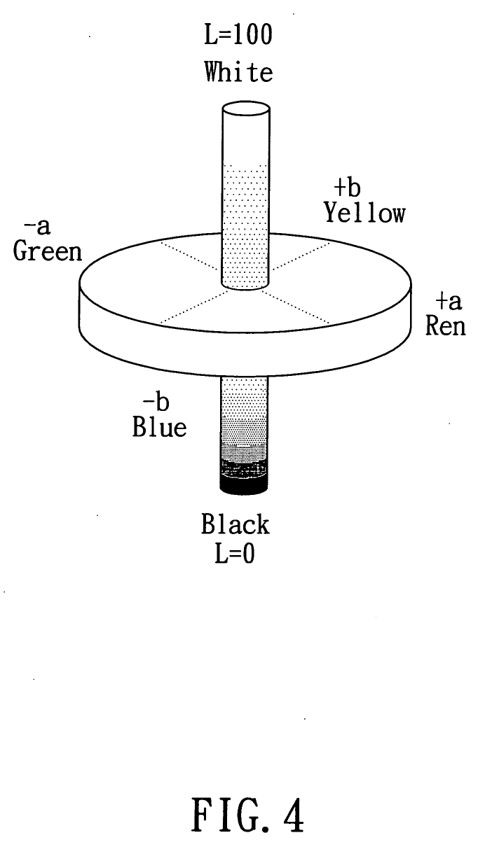

Referring to FIG. 4, the above values (L, a, and b) refer to CE 1976 (L*a*b) color space. Value “L” is within the range between 0 (black) and 100 (white), value “a” is within the range between green (−a) and red (+a), and value “b” is within the range between blue (−b) and yellow (+b).

From the above data, it can be seen that the color of light projected out of the backlight module does vary with the color of the brightness enhancement films.

It is much flexible to modify the color of LCD backlight by changing the color of an optical film than to correct the color of light sources. It is also relatively straightforward to apply pigments or dyes to the process of optical films production, and the users are allowed to select among many different colors as long as their optical films production is incorporated with a coating process or other processes can be pigmented or dyes.

What is claimed is:

1. A method for changing color of light projected outward from a backlight module, comprising
positioning a light source on a lateral side of a light guide of a backlight module;
adding pigments or dyes to a material of a chosen one of the optical films for changing color of said optical film in manufacturing said optical film; and
positioning said chosen optical film on the light guide for diffusing and enhancing brightness of light projected from said light source;
whereby light projected from said light source will be harmonized and mixed with colors of said pigmented or dyed optical films, and changed in its color when projected out of said backlight module.

2. The method for changing color of light projected outward from a backlight module as recited in claim 1, wherein said optical film is a diffuser, and is made by means of coating a plastic film substrate with a coating material having said pigments or dyes added thereto and mixed therewith.

3. The method for changing color of light projected outward from a backlight module as recited in claim 1, wherein said optical film is a brightness enhancement film, and is made by means of coating a plastic film substrate with a coating material having said pigments or dyes added thereto and mixed therewith.
